(19) United States
(12) Patent Application Publication
(10) Pub. No.: US 2019/0257106 A1
(43) Pub. Date: Aug. 22, 2019

(54) APPARATUS FOR CLIMATE CONTROLLED HOUSING FOR HYDROPONIC GROW ROOMS

(71) Applicant: FODDERTECH AMERICA, LLC, Sandy, UT (US)

(72) Inventor: Jon BAKER, Sandy, UT (US)

(73) Assignee: FODDERTECH AMERICA, LLC, Sandy, UT (US)

(21) Appl. No.: 16/333,983

(22) PCT Filed: Nov. 11, 2016
(86) PCT No.: PCT/US16/61592

§ 371 Date: Mar. 15, 2019

Related U.S. Application Data
(60) Provisional application No. 62/254,129, filed on Nov. 11, 2015.

(51) Int. Cl. E04H 5/08; A01G 31/02; E04B 1/76; E04B 1/348

(52) U.S. Cl. CPC E04H 5/08; A01G 31/02; A01G 2031/006; E04B 1/34815; E04B 1/7675

(57) ABSTRACT

Some embodiments of the invention include a hydroponic grow facility. The hydroponic grow facility, for example, may include a first shipping container comprising a first wall and a first corner post adjacent to the first wall, wherein the first wall has at least a portion of the first wall removed; a first fodder production apparatus disposed within the first shipping container; a second shipping container comprising a second wall and a second corner post adjacent to the first wall, wherein the second wall has at least a portion of the second wall removed, wherein the second corner post and the first corner post are coupled together; and a second fodder production apparatus disposed within the second shipping container.

### BACKGROUND

Economics are inextricably linked between the production of fodder or plant growth and the desirability of the same. The lower the overall capital and operating cost of producing fodder or growing produce, the more attractive it becomes. General benefits from increasing the general use of fodder include reduced carbon, water, and land footprint of livestock production, improved animal health and wellbeing, improved quality of animal products, and enhanced economics in livestock production. There is a need for low cost yet robust grow rooms for hydroponic and/or fodder production.

### SUMMARY

Some embodiments of the invention include a hydroponic grow facility. The hydroponic grow facility, for example, may include a first shipping container comprising a first wall and a first corner post adjacent to the first wall, wherein the first wall has at least a portion of the first wall removed; a first fodder production apparatus disposed within the first shipping container; a second shipping container comprising a second wall and a second corner post adjacent to the first wall, wherein the second wall has at least a portion of the second wall removed, wherein the second corner post and the first corner post are coupled together; and a second fodder production apparatus disposed within the second shipping container.

In some embodiments, the hydroponic grow facility may include an insulator disposed on one or more surface of the first shipping container and/or the second shipping container.

In some embodiments, the first shipping container and the second shipping container form a single chamber or volume.

In some embodiments, the hydroponic grow facility may include a polyurethane foam covering all, most, or some of the exterior walls, ceilings, and/or flooring of the first shipping container and/or the second shipping container.

In some embodiments, the hydroponic grow facility may include a plurality of fasteners coupled with either or both the ceiling or wall; and foam covering the fasteners and most of either or both the ceiling or wall.

In some embodiments, the hydroponic grow facility may include one or more beams disposed within either or both the first shipping container or the second shipping container, or above either or both the first shipping container or the second shipping container.

Some embodiments of the invention include a facility that may, for example, includes a first shipping container having four corner posts; a second shipping container having four corner posts; a first fodder production apparatus disposed within the first shipping container; a second fodder production apparatus disposed within the second shipping container; and a roof truss coupled with at least one corner post of the first shipping container and at least one corner post of the second shipping container.

In some embodiments, the truss spans the length of one or both the first shipping container and the second shipping container. In some embodiments, the truss comprises a first half truss and a second half truss that are coupled together near a central portion of either or both the first shipping container and the second shipping container.

In some embodiments, the facility may include a roof structure coupled with the truss.

In some embodiments, a corner post of the first shipping container and a corner post of the second shipping container are coupled together. In some embodiments, a corner post of the first shipping container and a corner post of the second shipping container are disposed next to one another.

Some embodiments of the invention include a vertical farming facility that may, for example, include a first shipping container; a first agricultural production facility disposed within the first shipping container; a second shipping container disposed on top of the first shipping container; and a second agricultural production facility disposed within the second shipping container.

In some embodiments, the first agricultural production facility and the second agricultural production facility comprise different types of agricultural production facilities. In some embodiments the first agricultural production facility and the second agricultural production facility comprise the same types of agricultural production facility.

In some embodiments, the vertical farming facility may include a third shipping container disposed on top of the second shipping container comprising a third agricultural production facility within the third shipping container.

In some embodiments, the vertical farming facility may include a plurality of shipping containers disposed one on top of the other, each of the plurality of shipping containers comprising an agricultural production facility within the respective shipping container.

In some embodiments, the first shipping container comprises infrastructure for the second shipping container. In some embodiments, the first shipping container comprises manure and/or water treatment equipment.

These illustrative embodiments are mentioned not to limit or define the disclosure, but to provide examples to aid understanding thereof. Additional embodiments are discussed in the Detailed Description, and further description is provided there. Advantages offered by one or more of the various embodiments may be further understood by examining this specification or by practicing one or more embodiments presented.

### BRIEF DESCRIPTION OF THE FIGURES

These and other features, aspects, and advantages of the present disclosure are better understood when the following Detailed Description is read with reference to the accompanying drawings.

FIG. 1 illustrates a multi-shipping container hydroponic grow facility according to some embodiments of the invention.

FIG. 2 illustrates a multi-shipping containers hydroponic grow facility according to some embodiments.

FIG. 3 illustrates a multi-shipping container hydroponic grow facility with two rows of shipping containers according to some embodiments of the invention.

FIG. 4 illustrates an example fodder production apparatus that may be housed within a multi-shipping container grow facility according to some embodiments of the invention.

FIG. 5 illustrates an example fodder production apparatus that may be housed within a multi-shipping container grow facility according to some embodiments of the invention.

FIG. 6 illustrates a shipping container according to some embodiments of the invention.

### DETAILED DESCRIPTION

A multi-shipping container hydroponic grow facility is disclosed that includes a plurality of shipping containers arranged together to create a grow facility that houses a fodder or plant growth production system according to some embodiments.

Embodiments of the invention include reusable, multiple used or new intermodal shipping containers arranged together to form large, contiguous, well insulated, climate controlled, free span, wide span, and/or almost free span grow facilities (e.g., multi-shipping container grow facility). These multi-shipping container grow facilities may be made of any size and/or configuration. In some embodiments, multi-shipping container grow facilities may not require any concrete or permanent foundation, and/or can be fitted with roofs (e.g., snow roofs or rain roofs or sun roofs) to further protect the facilities. In some embodiments, solar panels and/or batteries may be placed in and/or on a roof of a multi-shipping container hydroponic grow facility to generate a portion or all of the power required to control the internal climate and power all of equipment (e.g., pumps, filters, lights, etc.) useful for fodder or plant growth production.

In some embodiments, a roof may be coupled with the multi-shipping container hydroponic grow facility. In some embodiments, the roof may be held by free standing trusses that are coupled with or rest upon one or more corner posts of one or more shipping containers. In some embodiments, the roof may span the length and/or width of the various shipping containers.

In some embodiments, multiple shipping containers may be stacked vertically one upon each other to provide for a multi-story shipping container grow facility, which may, for example, increase the total amount of fodder or plant growth that can be produced per square foot of land. In some embodiments, a foundation may be used such as, for example, in embodiments having multiple containers stacked one upon each other. In some embodiments, a foundation may include reinforced corners where corner posts of the containers are located.

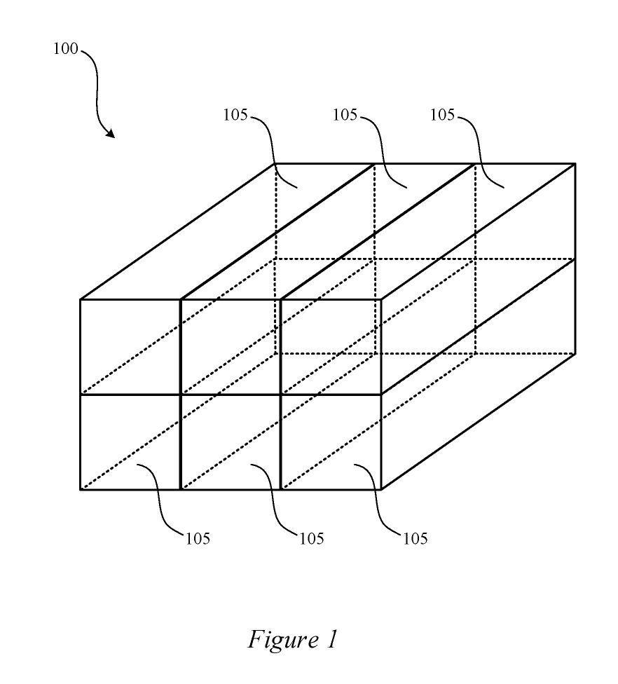

In some embodiments, a plurality of shipping containers may be placed side by side, end to end, and/or one on top of the other to create a multi-shipping container hydroponic grow facility as shown, for example, in FIG. 1. A multi-shipping container hydroponic grow facility 100 may combine multiple shipping containers 105 into a facility that has one or more interior spaces or fewer spaces than the number of shipping containers. In this example, six shipping containers 105 were used.

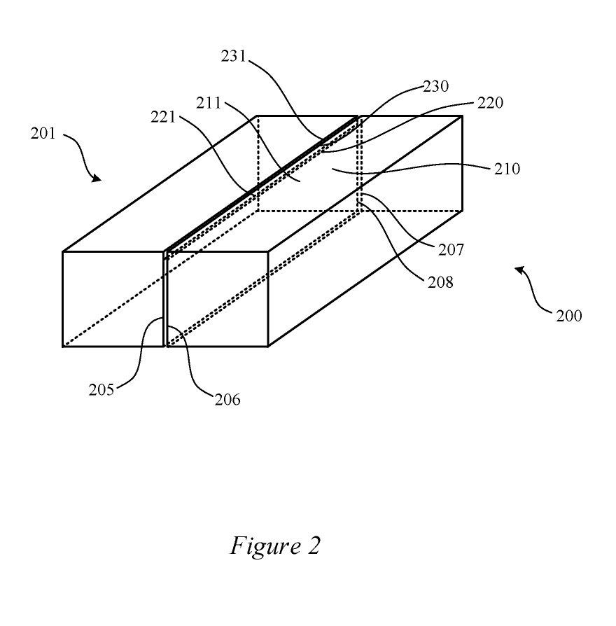

In some embodiments, shipping containers may be coupled together in any number of different ways as shown in FIG. 2. For example, the two corner posts 205 and 206 of two adjacent shipping containers 200 and 201 may be coupled together. For example, the two corner posts 205 and 206 of two shipping containers 200 and 201 may be bolted together, screwed together, welded together, tied together with metal cables, tied together with plastic cables, etc. Other adjacent corners of the two shipping containers 200 and 201 may also be coupled together. In some embodiments, the side walls 210 and 211 adjacent to the two corner posts 205 and 206 and the two corner posts 207 and 208 of each shipping container 200 and 201 may be removed, for example, prior to coupling the two shipping containers 200 and 201 together.

In some embodiments, the two corner posts 205 and 206 of the two shipping containers 200 and 201 may not be coupled together. In some embodiments, the two corner posts 207 and 208 of the two shipping containers 200 and 201 may not be coupled together. In such embodiments, for example, a floor and/or ceiling structure may couple the two shipping containers 200 and 201 together.

In some embodiments, all or portions of the side walls 210 and 211 may be removed using any number of techniques such as, for example, grinding, torch cutting, plasma cutting, blade cutting, etc. In some embodiments, all or portions of the side walls 210 and 211 may be removed after the two corner posts 205 and 206 (or corner posts 207 and 208) are coupled together. In some embodiments, nine foot high sections of the side walls 210 and 211 may be removed.

In some embodiments, additional beams 220 and 221 may be attached to the upper frame of each shipping container 200 and 201 above the walls 210 and 211 that have been removed. Without such reinforcement, for example, the shipping containers 201 and 200 may sag, for example, up to 4 inches and/or become unstable. If a shipping container's top side rail 230 and 231 is a 2″×2″ steel beam, for example, two additional beams 220 and 221 may be added that may comprise a 4″×2″ steel beam. Various other beams of various dimensions and/or sizes may be used such as, for example, a 2″×2″, 2″×4″, 4″×4″, or 6″×6″. Beam strength, for example, may be a function of the depth of beam. In some embodiments, holes may be drilled through the top side rail 230 and 231 an additional beam 220 and 221 may be coupled with the respective top side rail 230 and 231. In some embodiments, the additional beams 220 and 221 may include a beam or channel and/or may have any structural shape such as, for example, a box beam, C-channel, a I-beam, an L-channel, etc. In some embodiments, more than one additional beam may be coupled with each of the top side rails 230 and 231. In some embodiments, an additional beam of any size may be used. In some embodiments, a single additional beam may be coupled with beneath or on top of the shipping container rail or roof.

In some embodiments, the additional beam 220 or 221 may span the length of the top side rail 230 or 231. In some embodiments, the additional beam 220 or 221 may span only a portion of the length of the top side rail 230 or 231. Various lengths and/or sizes of additional beams 220 and 221 may be used. The additional beams 220 and/or 221, for example, may support the weight of the shipping container 200 and/or 201 with the wall 210 and/or 211 removed. In some embodiments, a single additional beam may be used to support both shipping containers 200 and 201. Additional beams 220 and 221 may be coupled with the top side rail 230 or 231, for example, using bolts, screws, welding, etc. In some embodiments, doors, windows, exits, entrances, holes, etc. may be cut into any external wall of either or both shipping containers 200 and 201, for example, in locations and sizes to facilitate ingress and egress from the facility or for other purposes. In some embodiments, the original shipping container doors may be closed and/or sealed. In some embodiments, the original shipping container doors may be sealed over on the inside of the facility to become part of an insulated wall.

In some embodiments, flooring may be placed on top of the bottom of the shipping container. The flooring, for example, may be constructed at least in part from wood, tile, plastic, metal, rubber, concrete, etc. In some embodiments, the flooring can be placed over any joints between two adjacent and/or coupled containers, for example, to help unify the structure. In some embodiments, waterproof and/or wear resistant floor coverings can be placed on top of the flooring such as, for example, linoleum sheet, EPDM rubber roofing material, or other such membrane or surface.

In some embodiments, the multi-shipping container hydroponic grow facility may be air tight, for example, to prevent the entrance of mold spores and/or vermin from the outside. In some embodiments, the multi-shipping container hydroponic grow facility may be insulated, for example, to reduce the amount of energy required to climate control the facility. In some embodiments, pourable polyurethane foam insulation (or other insulation materials) may be used to cover all, most, or some of the exterior all walls, ceilings, and/or flooring of the multi-shipping container grow facility, for example, to achieve the maximum amount of R value (e.g., ˜6.5 per inch of thickness). In some embodiments, insulation may be used to seal any holes, pricks, corroded portions, gaps, joints, etc. in the exterior of the shipping container.

In some embodiments, forms or molds may be used to hold the expanding insulation (e.g., poured urethane or poured polyurethane) into the desired final shape. In some embodiments, the forms or molds may hold the insulation into walls and ceiling to create a single large room (or fewer rooms than the number of shipping containers) with no cracks, air leaks, etc. In some embodiments, the molded foam surfaces may be sanded, painted, and/or have more durable surfaces glued or attached. In some embodiments, the foam may be tinted prior to or during mixing. In some embodiments, the forms or molds may be removable and/or reusable.

In some embodiments, wireless lighting and/or LED lighting systems may be distributed throughout the interior of the multi-shipping container grow facility. In some embodiments, wireless lighting, wired lighting, grow lights, and/or LED lighting systems may be coupled with the ceiling of one or more shipping containers, and/or the additional beams. In some embodiments, lighting systems may include wires or electrical cords, conduits, and/or cables that run under the floor, on the roof, within a wall, etc. of one or more shipping containers. In some embodiments, extension power cords, for example, may be pulled underneath the containers in the void created by the bottom structural supports built into each shipping container. In some embodiments, extension power cords, for example, may be passed up into the multi-shipping container hydroponic grow facility at proper locations to power pumps and controls. In some embodiments, passive or active sunlight harvesting devices such as, for example, solar tubes (e.g., Solateube), sun trackers (e.g., SunTraker or SunDolier) may be used to in place of or in addition to LED lighting. Passive or active sunlight harvesting devices may include fiber optics, windows, sunlight capturing dishes (e.g., Parans), lenses, mirrors, etc.

In some embodiments, holes may be cut in the floor of one or more shipping containers to allow the cords, wires, pipes, tubes, hoses, etc. to run into the multi-shipping container grow facility. In some embodiments, holes may be cut in the floor of one or more shipping containers to allow the water inlet and/or outlet to and/or from the multi-shipping container grow facility.

In some embodiments, a multi-shipping container hydroponic grow facility may be a large area, free span, well insulated and/or floored facility that may include one or more fodder or plant growth production systems.

In some embodiments, the multi-shipping container hydroponic grow facility may include one or more environmental control units such as, for example, one or more A/C units (e.g., wall, roof, or ground mounted), one or more heaters, and/or one or more dehumidification units. In some embodiments, the one or more environmental control units may be disposed on the roof, floor, or walls of the multi-shipping container grow facility. In some embodiments, one or more drains, power connections, electrical cords or wires, and/or water connections may be included.

In some embodiments, one or more truss may be welded or otherwise attached to the roof of one or more shipping containers. In some embodiments, the one or more truss may be welded or attached to one or more upper frames of the containers with any pitch or slope.

In some embodiments, roof shingles may be constructed from the side wall panel material. In some embodiments, about 30-50% more side wall panel material may be removed from the shipping containers than what is needed for the roof shingles. As such, if a portion of the panel is too dented or rusted to be usable, it can be discarded in favor of better shingles. In some embodiments, the shingles may be welded, screwed, bolted, or riveted onto roof trusses.

In some embodiments, the flooring may include wood sheets such as OSB. In some embodiments, the wood sheets may be used in combination with pourable foam so as to structural insulated floor panels. The shipping container floor, for example, may serve as one side of a sandwich panel. The wood sheet may be supported with one or more pieces of 2×4 or equivalent structure. Foam may then be poured through a hole drilled into the OSB and allowed to foam. The wood sheet, for example, may be more than or about 3.5 inches or some other height above the shipping container floor. The new floor may provide a good floor surface and may provide good thermal insulation. In some embodiments, the flooring may include a structural insulated panel that may include, for example, a plywood layer (e.g., an original shipping container floor), polyurethane foam in the middle, and/or OSB on the top.

Most shipping containers include a twist lock receptacle that can be used in conjunction with a twist lock to physically connect one shipping container with another shipping container. One or more plates with holes may be welded to a twist lock receptacle of a shipping container or the rail or post. The twist lock with welded plates may be inserted into the top hole of the twist lock receptacle on the selected corner posts (both outside wall sets of corner posts and every first set on all interior containers to create 8 ft. centers for roof trusses. The trusses may, for example, extend the full length of the container.

In some embodiments, a roof truss may be made of welded steel tubular pieces. In some embodiments, a roof truss may be greater than the total length of a container with allowance for extra length that may be required by the truss being at an angle to horizontal. In some embodiments, the roof truss may comprise two half trusses coupled with corner posts, corner fittings and/or twist lock portions of a shipping container and/or coupled together (e.g., with pins, screws, bolts, welds, rivets, etc.) above a middle portions of the shipping container. The ends of two half trusses may have plates and/or holes that allow them to be pinned together above the center of a container to form a single long truss (e.g., 40-45 ft.). In some embodiments, each half truss may be inserted and/or pinned to the twist lock assembly or the corner fitting. Each half truss may sit at a given angle (e.g., 20-30 degrees) above the container roof After both half trusses have been attached to the corner posts, weight is distributed to the two center ends of the half trusses to bring the trusses down and together, where they are pinned together. This can create a wide range of spring or tensioning in the completed truss (e.g., similar to a spring bar tent system). All weight placed on the truss will now be transferred via the truss to the corner posts, which are designed for heavy loads. It will be possible, for example, to place loads of 50 lbs, 100 lbs, 150 lbs or even more per square foot on the “independent” truss roof. In some embodiments, the trusses may be made from wood, aluminum, plastic, or any other suitable material.

In some embodiments, one or more steel plates (e.g., 4″×4″ steel plates) may be welded onto the two exposed 2″×2″ inch top side rails above where a portion of a wall may have been removed (e.g., the middle of the wall or where the wall may sag). Each plate may have a vertically oriented metal ring pre-welded onto it. Once the plates are welded in place, a tensioning cable with hooks can be attached to the vertical ring and/or the truss.

The tensioning cable may or may not include a spring, turnbuckle, or other tensioning device. This configuration, for example, may create a suspension force to hold up the weakened top side rails. In this way, for example, the weakened top side rails may be held in place without any steel being added inside the facility to reinforce the rails. Various other devices may be used other than a ring or a vertical ring so long as the tensioning cable to pull upwards on the rail where the wall or rail may sag. In some embodiments, both rail members may be pulled upwards.

Once the trusses are in place, the side wall panels may be cut out. These side wall panels, for example, may have 9 ft. lengths and/or 9 ft. widths creating 9 ft.×9 ft. shingles. These shingles, for example, may be placed in a shingled overlap on the 8 ft. trusses. These shingles, for example, may help to unitize the roof and indirectly the entire facility.

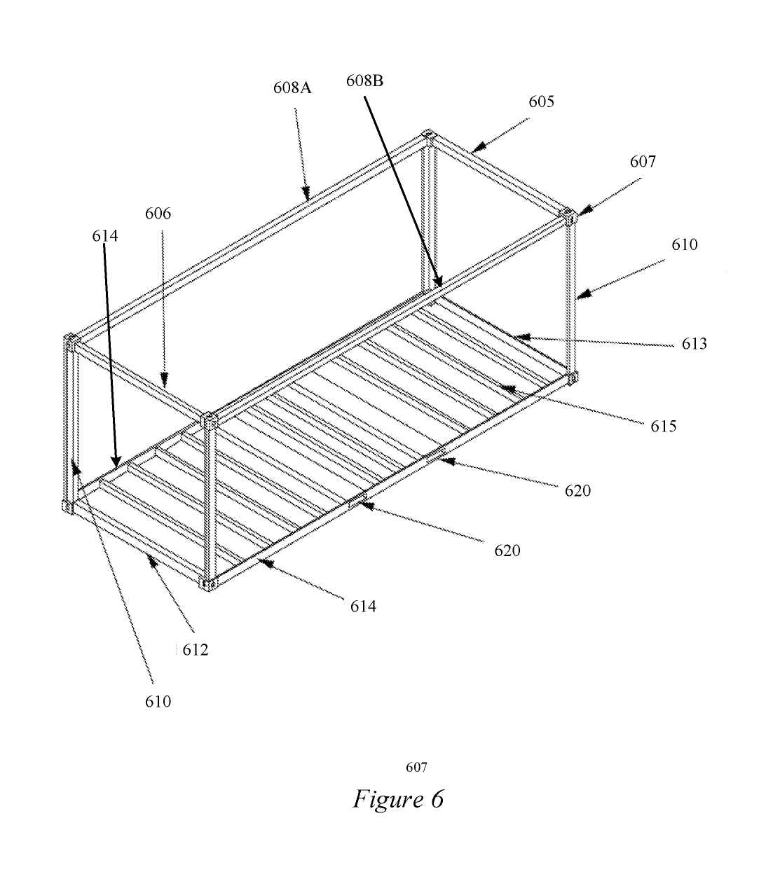

In some embodiments, one or more awnings may be added to help shade the facility. In some embodiments, one or more poles may be inserted into the side holes of a corner post fitting (See FIG. 6). A shade cloth can be hung or coupled with the poles to screen the afternoon sun from the facility if so desired. The poles may extend horizontally or at an angle from the side posts.

In some embodiments, side wall paneling that may be removed from some of the side walls of the shipping containers may be secured (e.g., screwed) onto the truss (e.g., in long shingles), for example, to provide additional long term protection against the elements including snow, rain, and sun. In some embodiments, if portions of the side wall panels have puncture holes or are too severely bent to be used, the panels may be cut into smaller lengths and then placed and screwed onto the truss as shorter shingles.

In some embodiments, the multi-shipping container hydroponic grow facility may include solar panels disposed on the roofs of one or more shipping containers. In some embodiments, the multi-shipping container hydroponic grow facility may include solar panels disposed on a truss framework. Various batteries, DC to AC converters, and/or control circuitry may also be included.

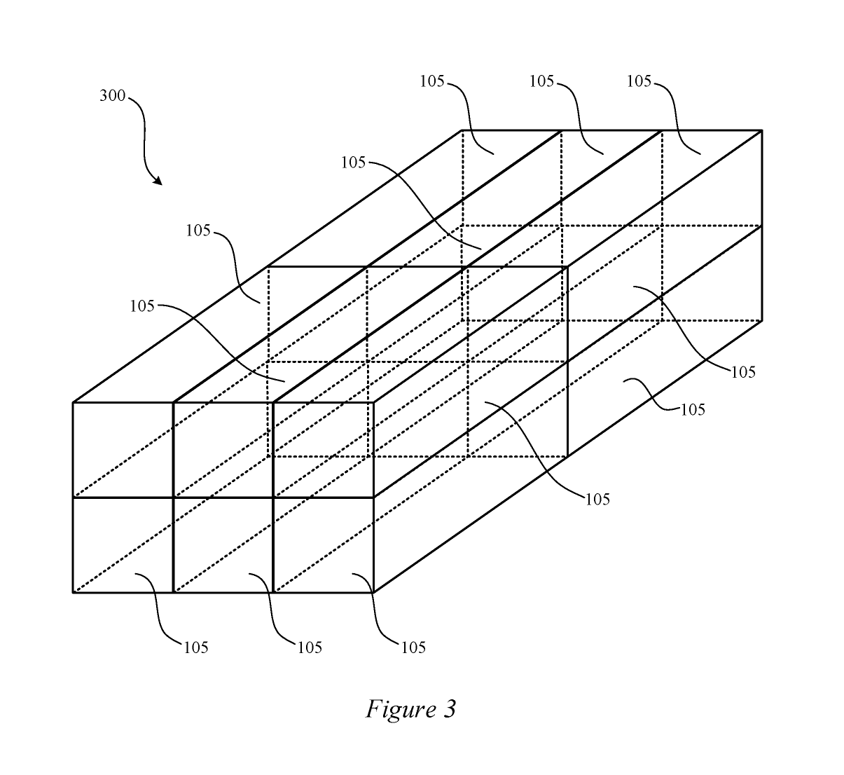

In some embodiments, the multi-shipping container hydroponic grow facility 300 may include two rows of shipping containers 105 as shown in FIG. 3. For example, a second row of shipping containers may be placed end to end with a first row of shipping containers. In such embodiments, for example, wide original container doors may be removed and the open ends placed together to form a double row of containers. Multi-shipping container grow facilities made of two or more rows of containers may include a row of vertical uprights (e.g., the former container corner posts) situated in a line within the now double long facility. As such the entire double width of the facility may freely span either side of this single line of posts. In some embodiments, a multi-shipping container hydroponic grow facility can accommodate such lines of support posts. For multi-shipping container grow facilities with three or more rows of containers placed end to end, for example, at least one set of containers may have both ends of the container removed whether consisting of doors on one end and wall on the other or doors on both ends. In some embodiments, for example, very large fodder or plant growth facilities (e.g., measuring 100's of feet in width and/or length) can be quickly assembled from shipping containers. In some embodiments, the shipping containers may be disposed such that double container doors may be placed on both ends of the container facility and/or in the middle of the container facility.

In some embodiments, a multi-shipping container hydroponic grow facility may include a plurality of shipping containers in multi-story configurations where one row of shipping containers are stacked on a second row of shipping containers. In some embodiments, multi-story configurations can include the same configurations. In some embodiments, additional openings may be cut into the floors, walls, and/or ceilings to facilitate the transport of harvested fodder, of grain seed, nutrients, and/or other inputs to the fodder production process. In some embodiments, stairs, elevators, lifts, ladders, pulleys, dumbwaiters, etc. may be included within or without the multi-shipping container grow facility. In some embodiments, a shipping container may be disposed on its end and used as a grain silo, elevator shaft, stairwell, etc.

In some embodiments, a multi-shipping container hydroponic grow facility may be moved or transported, for example, by removing the roof truss and shingles, disconnecting the top side rail roof beam enhancements, making select cuts in the walls and flooring along the joint lines, etc. As such, for example, a multi-shipping container hydroponic grow facility may be considered to be transportable and/or temporary structures and may not require permanent concrete foundations. In some embodiments, a multi-shipping container hydroponic grow facility may be placed on a pad with either or both water and power connections or sources.

In some embodiments, a multi-shipping container hydroponic grow facility may be used to convert one or more shipping containers into a grow facility.

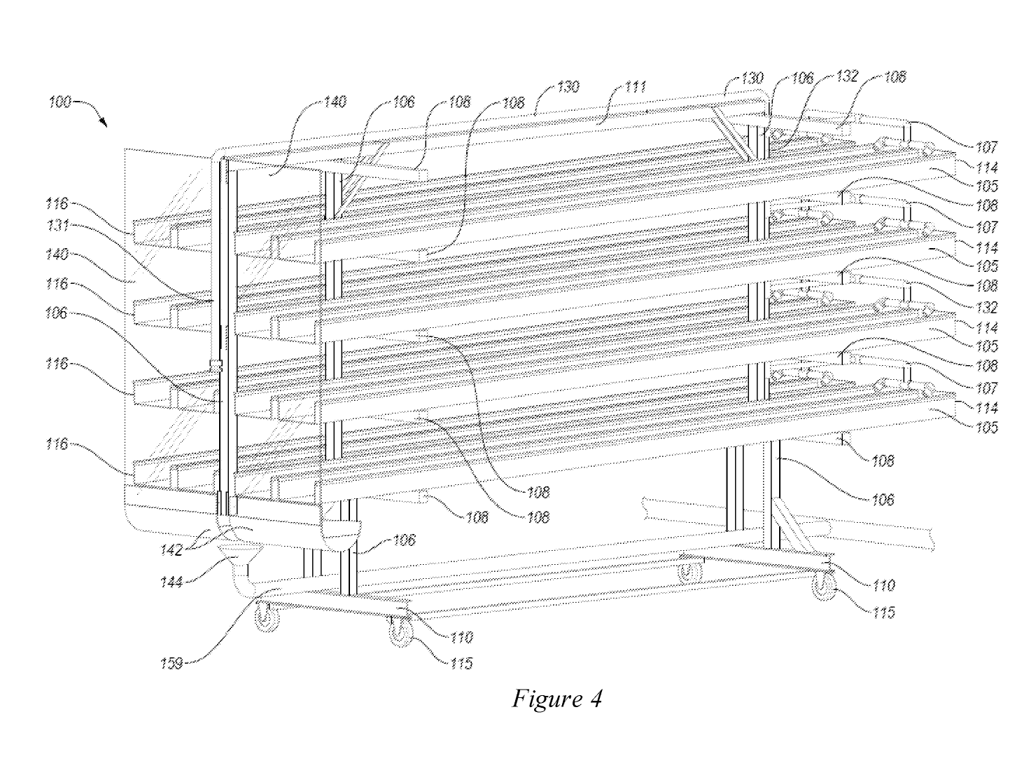

FIG. 4 illustrates an example fodder production apparatus 100 that may be housed within a multi-shipping container grow facility. In some embodiments, more than one hydroponic grow apparatus may be housed within a multi-shipping container grow facility.

In some embodiments, the fodder production apparatus 100 may include a structure that includes at least two vertical members 106 connected by one or more horizontal members 108. In these and other embodiments, the vertical members 106 may also be coupled with a base 110 and a top member 111. In some embodiments, the base 110 may include a plurality of casters 115. In some embodiments, a structure of the fodder production apparatus 100 may be designed and constructed to carry the weight of the various other components of the fodder production apparatus and/or make it possible for the fodder production apparatus 100 to be moved between various positions. In some embodiments, the various components of the structure may be constructed from metal, composite, plastic, or other materials. Also, in some embodiments, the various components may be constructed from box beams, I-beams, U-beams, etc.

The structure of the fodder production apparatus 100 may support a plurality of fodder troughs 105. In some embodiments, for example, sixteen (16) or more or fewer fodder troughs 105 may be supported by the horizontal members 108. In some embodiments, each of the horizontal members 108 may support one or more fodder troughs 105 on each side of the vertical members 106. In some embodiments, the fodder troughs 105 may be used to house seeds and/or water, which may include nutrients for fodder growth and production. In some embodiments, the fodder troughs 105 may be securely and/or removably attached to the structure such as, for example, with one or more of the horizontal members 108. In some embodiments, each fodder trough 105 may have an elongated cuboid shape that is open on the top and open at one end. The two open surfaces of the elongated cuboid, for example, may be roughly orthogonal. Each fodder trough 105 may have any size or configuration. For example, the fodder troughs 105 may be 9″ wide, 3″ deep, and 4 meters long along the elongated length. Various other sizes and/or dimensions may be used. In some embodiments, each fodder trough 105 may generally have a trough shape that may be open top along one elongated length and one end. Each fodder trough 105, for example, may have a capped end 114 and an uncapped end 116 on opposite ends of the trough. In this way, each fodder trough 105 may be a partially closed trough.

Various fodder production apparatus 100 configurations may be used. For example, a fodder trough 105 may be used with both ends capped and an open top. A lower portion of one end of the fodder trough 105 may include one or more gaps, slits or holes that are sized smaller than a seed but large enough for water to pass through. The one or more gaps, slits or holes may have one or more dimensions equal to or less than 5 mm, 4.5 mm, 4 mm, 3.5 mm, 3 mm, 2.5 mm, 2 mm, 1.5 mm, 1 mm, 0.5 mm, 0.25 mm, 0.125 mm, etc.

In some embodiments, the fodder troughs 105 may be arranged within the fodder production apparatus 100 at an angle to permit water to flow from the capped end 114 to the uncapped end 116. The troughs, for example, may be arranged at angle of 0.5°, 1°, 1.5°, 2°, 2.5°, 3°, 3.5°, 4°, 4.5°, 5°, etc. relative to horizontal. In other embodiments, for example, the troughs may be arranged at an angle greater the 5° from horizontal. This angled configuration may be made in a number of ways. In some embodiments, two horizontal members 108 supporting each trough may be positioned at different vertical positions on the vertical members 106. For example, the horizontal members 108 near the capped end 114 may be positioned higher relative to the horizontal members 108 near the uncapped end 116 of the fodder troughs 105. In some embodiments, the casters 115 coupled with the base 110 may include vertical adjustment mechanisms. In this embodiment, the casters 115 near the capped end 114 of the fodder troughs 105 may be adjusted to increase the height of the fodder production apparatus 100 near the capped end 114 of the fodder troughs 105 relative to the uncapped end 116 of the fodder production apparatus 100.

In some embodiments, the fodder production apparatus 100 may include one or more doors 140. In some embodiments, the doors 140 may be coupled with a vertical member 106. In these and other embodiments, the vertical member 106 may be coupled with the end of one or more portions of the structure such as horizontal members 108. When closed, the doors 140 may be positioned at an angle, φ, relative to the fodder troughs 105. For example, if the fodder troughs 105 are oriented at an angle relative to horizontal to encourage water flow through the fodder troughs 105, then the doors 140 may be positioned less than 90° relative to the troughs when the doors 140 are closed. In some embodiments, the doors 140 may be positioned vertically, or 90° relative to horizontal, and the fodder troughs 105 may be angled at less than 5° relative to horizontal.

In some embodiments, the doors 140 may be transparent, which may, for example, allow a person to check a drainage state of the water with the naked eye. In some embodiments, a transparent pane 156 may be fitted into a frame 157 of the door 140.

In some embodiments, an inner surface of the doors 140 may contact the top of the fodder trough 105 but may not contact the bottom of the fodder trough 105, which may result in a gap 160 along the bottom of the fodder trough. In some embodiments, the fodder trough 105 may be positioned at an angle, θ, relative to horizontal. In some embodiments, the door 140 may be positioned vertically. In this way, the fodder trough 105 and the door 140 may not be disposed at right angles relative to one another. This non-square configuration may result in the door 140, when closed, being in contact with the top of the fodder trough 105 but not in contact with the bottom of the fodder trough 105, which may result in a gap 160 along the bottom of the fodder trough. The gap 160, for example, may be equal to or less than 5 mm, 4.5 mm, 4 mm, 3.5 mm, 3 mm, 2.5 mm, 2 mm, 1.5 mm, 1 mm, 0.5 mm, 0.25 mm, 0.125 mm, etc. This gap 160, in some embodiments, may be sized to allow water to flow through the gap 160 but block seeds from passing through the gap 160. Thus, the door 140, when closed, may be configured to transfer water that flows from the fodder trough 105 down the face of the door 140 to a water collection gutter 142 or another water collection system.

While two doors 140 are illustrated, a single door may be used. In some embodiments, the one or more doors 140 may be hinged or pivoted from any location on, near or off the structure and/or on, near, or off the fodder troughs 105. For example, a single door 140 may have one or more hinges on the vertical member 106. As another example, a single door 140 may have one or more hinges above the various fodder troughs 105 and may swing downward to close and swing upward to open. As another example, a single door 140 may have one or more hinges below the various fodder troughs 105 and may swing upward to close and swing downward to open. As another example, a single door 140 may have one or more hinges on one side of the structure. The hinges may allow the doors 140 to be opened.

Furthermore, in some embodiments, one or more of the doors 140 may be replaced with any vertical planar member or a structure having one or more planar surfaces. In some embodiments, a vertical planar member may include a wall, a sheet, a lid, a box, or any other apparatus that restricts the flow of water out the opened end 116 of the fodder trough 105 yet retains the seeds in the fodder trough 105. In some embodiments, the vertical planar member may be secured to the troughs and/or structure any number of ways such as for example, using bungee cords, screws, bolts, clamps, knobs, locks, buttons, snaps, hooks, straps, screws, bolts, clips, Velcro®, resistance forces, etc.

In some embodiments, the vertical planar members and/or the doors 140 may be constructed of wood metal, plastic, Plexiglas, Lexan, etc. In some embodiments, an inner surface of the vertical planar member and/or the door 140, along which water may flow, may be constructed of acrylic or a similar material.

In some embodiments, the one or more doors 140 may be replaced with a removable cap that may be secured on the uncapped end 116 of the fodder trough 105. In some embodiments, the removable cap may include a gap disposed at the bottom of the cap and/or between the cap and the bottom of the fodder trough 105. In some embodiments, the gap may be sized and/or positioned to allow water to flow from the fodder trough 105 yet small enough to restrict the flow of seeds outwardly from within the fodder trough 105. The cap may be removable to allow for harvesting of the fodder. The cap may be removably attached with the fodder troughs 105 using bungee cords, screws, bolts, clamps, knobs, locks, buttons, snaps, hooks, straps, screws, bolts, clips, Velcro®, resistance forces, etc.

Some embodiments may include one or more small doors coupled with each tray that include a gap or slit sized and/or positioned to allow water to flow from the fodder trough 105 yet small enough to restrict the flow of seeds outwardly from within the fodder trough 105. The one or more small doors may be hinged from the top, side or bottom of each trough to allow the doors to be opened and the fodder removed from the fodder troughs 105. Various other configurations of doors, large or small, may be used without limitation. In some embodiments, an attachment mechanism may be used to secure the doors 140 in a position coupled with a portion of the fodder troughs 105. The attachment mechanism may include a bungee cord, a latch, a lock, etc.

Various other door and/or door opening configurations may be used. For example, a single door may swing from one side of the fodder production apparatus 100. As another example, a single door may swing from the top of the fodder production apparatus 100. As another example, two doors may swing from the outside of the fodder production apparatus 100 and close toward the center of the fodder production apparatus 100. Regardless of the door swing and/or location, in the closed position the doors 140 may top of the uncapped end of the fodder troughs 105.

In some embodiments, the fodder production apparatus 100 may include a plurality of water pipes. The water pipes may include a central pipe that transports water from a water supply to the plurality of fodder troughs 105. In some embodiments, the central pipe may transport water from one end of the fodder production apparatus 100 to the other end. In some embodiments, the central pipe may include a horizontal pipe 130 coupled with a vertical pipe 131 and a vertical pipe 132. In these and other embodiments, the vertical pipe 132 may be coupled with a plurality of water delivery pipes 107 that channel water into the plurality of fodder troughs 105. In some embodiments, the water delivery pipes 107 may be positioned near the capped end 114 of the fodder trough 105. The vertical pipe 131 may be coupled with a water supply, which may include a storage tank, a filter, and/or a pumping system.

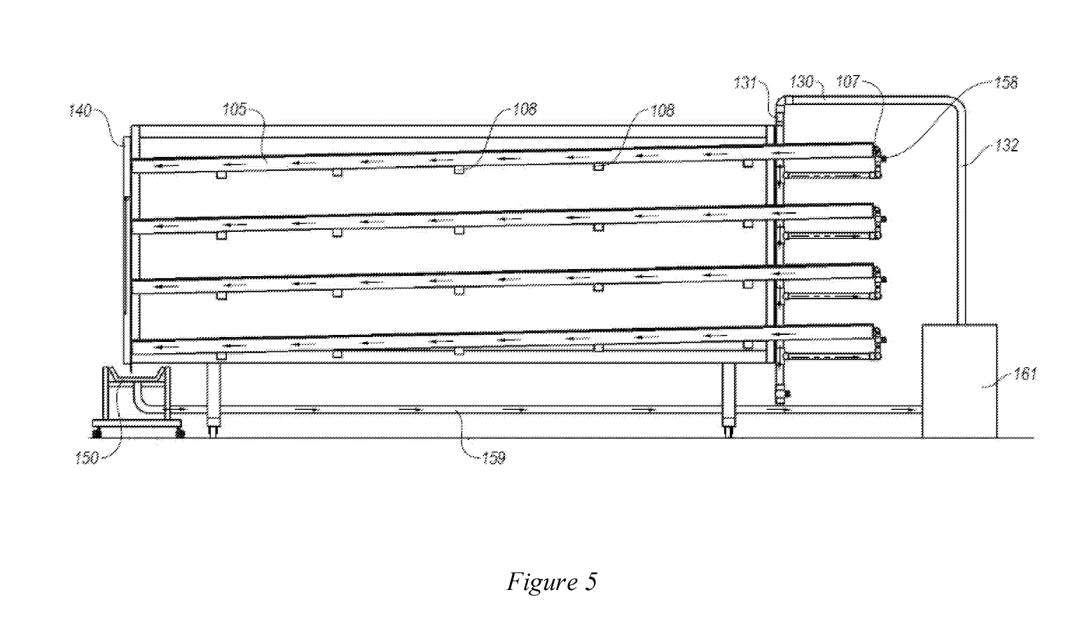

Various other water pipe configurations may be used. For example, as illustrated in FIG. 5, the vertical pipe 132, which may be coupled with a water supply 161, may be located at a back of the fodder production apparatus 100. The vertical pipe 131 may be coupled with a plurality of water delivery pipes 107 that channel water into the plurality of fodder troughs 105. In some embodiments, a particular water delivery pipe 107 may be connected to a capped end of a particular fodder trough 105. In these and other embodiments, the water delivery pipes 107 may each include a control valve 158 to control flow of water to the fodder trough 105. In some embodiments, a transfer pipe 159 may be coupled with the water collection trough and may transfer water from the water collection trough to the water supply 161.

In some embodiments, the water collection trough may be included. The water collection trough may include a half pipe 152 and casters 155. Various pedestals, supports, or bases may be included between the half pipe 152 and the casters 155. While only two casters 155 are illustrated, any number of casters may be used. The half pipe 152 may be used to catch, hold and/or drain water from the fodder production apparatus 100 that trickles from the fodder troughs 105 down the doors 140. The water collection trough may be positioned underneath the doors 140 in order to collect the water. The water collection trough may have a length that may be longer than the width of a single fodder production apparatus 100 or a length that spans the width of multiple fodder production apparatus 100. The casters 155 may be used to slide the water collection trough away from the fodder production apparatus 100 when the doors are opened to remove fodder from within the troughs. In some embodiments, multiple water collection troughs 150 may be coupled together with pipes, flexible tubes, hoses, etc.

In some embodiments, the water collection trough may be sloped from one end to another to facilitate flow of water through the water collection trough from one end to another. In some embodiments, each end or a single end of the water collection trough may be capped. In some embodiments, a lower capped end may be coupled with a tube, hose, or pipe that may be connected to a drain or water supply, which may include a storage tank, a filter, and/or a pumping system.

In some embodiments, each of one or more doors 140 may include a water collection gutter 142 according to some embodiments. The water collection gutter 142 may be used in addition to or as an alternative to the water collection trough. In some embodiments, the water collection gutter 142 may include a half pipe, which may be used to catch, hold, and/or drain water from the fodder production apparatus 100 that trickles from the fodder troughs 105 down the door 140. In some embodiments, the water collection gutter 142 may be positioned at a bottom of the door 140 lower than a lowest fodder trough 105. In some embodiments, the water collection gutter 142 may be extend inwardly on an interior side of the door 140, and when the door 140 is closed, the water collection gutter 142 may be positioned beneath the opened end 116 of the fodder trough 105. In some embodiments, the water collection gutter 142 may have a length approximately equal to a width of the door 140 and/or one or more fodder troughs 105 from which the water collection gutter 142 collects water.

In some embodiments, each end or a single end of the water collection gutter 142 may be capped. In some embodiments, an end of the water collection gutter 142 may be disposed above and/or at least proximate to a funnel 144 with which water may be directed. Alternatively or additionally, one end of the water collection gutter 142 may be uncapped and the other end of the water collection gutter 142 may be capped.

In some embodiments, the water collection gutter 142 may be disposed horizontally and may not be sloped. Alternatively or additionally, in some embodiments, the water collection gutter 142 may be sloped from an upper end of the water collection gutter 142 to a lower end of the water collection gutter 142 to facilitate flow of water through the water collection gutter 142 from the upper end to the lower end. In these and other embodiments, both ends of the water collection gutter 142 may be uncapped. In some embodiments, the water collection gutter 142 may be sloped towards the funnel 144, which may be disposed beneath and at least proximate the lower end of the water collection gutter 142, facilitating flow of water through the water collection gutter 142 to the funnel 144.

In some embodiments, the funnel 144 may be disposed beneath and at least proximate the ends of multiple water collection gutters 142. For example, the funnel may be disposed beneath the ends of two water collection gutters 142 coupled with two doors 140 of the fodder production apparatus 100.

In some embodiments, the funnel 144 may be replaced by another water collection device, such as, for example, a pipe. In some embodiments, the funnel 144 may be coupled with a tube, hose, or transfer pipe 159 that may be connected to a water supply 161. In some embodiments, the funnel 144 may be spaced apart from the water collection gutters 142 so as to allow the doors 140 to open and close freely. However, in some embodiments, the funnel 144 and/or the transfer pipe 159 may be directly connected to an end or a bottom of the water collection gutter 142.

In some embodiments, the water collection gutters 142 may be secured to the doors 140 any number of ways such as, for example, using screws, bolts, clamps, knobs, locks, buttons, snaps, hooks, straps, clips, Velcro®, resistance forces, etc. In some embodiments, the water collection gutters 142 may be selectively removable from the doors 140.

Some embodiments include the combination of twist lock technology coupled with one or more roof trusses that may allow for an independent (or partially independent) roof system above a shipping container regardless of the use of the container.

Some embodiments include using pourable foam to create an interior insulated wall or floor in a shipping container that may be thin, monolithic, air tight, functional, etc. Other types of foam or insulation may be used such as, for example, sheet insulation, spray foam insulation, etc.

Some embodiments include ceiling/wall support enhancers to ensure that the foam layer never completely separates from the metal wall surfaces of shipping containers.

Some embodiments include multi-shipping container systems for use as hydroponic grow rooms. The multi-shipping container systems may include walls that have been cut away to form a room from two or more shipping containers. The multi-shipping container systems may include multiple shipping containers coupled together to create one or more rooms. The multi-shipping container systems may be used to grow any type of produce or product such as, for example, grain, corn, wheat, grass, fruit, vegetables, marijuana, fodder, etc. Grow operations are usually enhanced when there are large open areas to locate the grow trays and related equipment in. In some embodiments, the multi-shipping container systems may include climate control systems, grow lights, ladders, stairs, plumbing, filters, piping, conveyers, etc.

Some embodiments include multi-shipping container systems for any agricultural use such as, for example, workshops, warehousing, storage, etc.

Some embodiments include a weld plate with a vertical ring for use in suspending/holding up a shipping container roof. In some embodiments, this may help hold up a weakened shipping container with portions of wall panels removed from the shipping container and/or may allow for another shipping container to be stacked upon the weakened shipping container.

In some embodiments, portions of side panels may be removed from a shipping container and used as part of the roof. These panels, for example, may include 8′-9′ panels or panels of any size and/or dimension.

In some embodiments, an upper side rail (e.g., where the wall panel has been removed) can be pinned (e.g., bolted, screwed, welded, etc.) to the bottom undercarriage of the shipping container above.

The shipping containers described in this document may have any dimension. For example, the shipping containers may have an height of 7′ 9″ or 8′ 10″ and/or an external height of 8.5′ or 9.5′.

In some embodiments, foam may be secured to the ceiling of a shipping container using, for example, non-rusting metal strips (e.g., aluminum or stainless) every number of feet to support the foam on the ceiling. These strips, for example, may be screwed into the base of the upper side wall rails.

In some embodiments, foam may be secured to the ceiling of a shipping container using, wood screwed into the ceiling prior to pouring the foam. For example, short (1-1.5″) nails, screws, or similar anchors can be used to couple small pieces of wood (or other material) to or near the inner surface of the metal shell (e.g., roof and/or walls) of the shipping container (whether vertically down or from the side walls). These screws or nails may penetrate the metal skin enough to firmly hold the foam in place. The wood pieces may include scrap wood, perhaps 0.25-1 inch thick and a few inches long and/or wide. The wood would be installed prior to foaming. The foam would flow all around and fill in against the wood and the nails/screws. Once the foam hardens, it encases the wood supports and may anchor the foam wall to the metal without leaving any visible trace of the wood. The foam itself would seal any puncture wound in the metal skin against weather or water.

In some embodiments, a round magnet (e.g., ⅜ to ½ inch diameter) with a nail or other member coupled with the magnet. The magnet could be drilled through and the nail may be inserted through the magnet. The nail, for example, may be driven into the wood and perhaps bent at its exit point to ensure that it never separates from the wood strip. These magnets with a nail can be distributed throughout the inside of the shipping container to aid in securing the foam to the shipping container walls and/or ceiling.

Multi-shipping container systems may be used for animal housing. For example, the Multi-shipping container system may include an HVAC or fan system that may include a filter to remove fumes. As another example, the Multi-shipping container system may include a lower floor and/or manure removal system. As another example, sun roofs, light pipes, and/or windows may be added. As another example, water, feed, resting spaces, etc. may be included.

Some embodiments include vertical farming and/or agriculture that is conducted in shipping containers stacked upon one another. Vertical farming or agriculture may include a multi-story shipping container system. In some embodiments, the top story may hold fibrous feed storage for animals. In some embodiments, another story (or stories) may include fodder systems to produce fresh feed to mix with the fibrous feed from the top story. The bottom stories may include X levels of animal housing Animals might include broilers, layers, swine, beef, chicken, goats, sheep, rabbits, turkeys, and/or dairy animals. In dairy systems, for example, a milking systems may be included (whether parlors, rotaries, or robotic systems). In some embodiments, the lower level(s) might contain milk storage/processing equipment, manure processing equipment (e.g., anaerobic digesters, composting, or solid/liquid separation, etc.). in addition to possibly a farm store.

Other stories, for example, may include hydroponic grow stations. Other stories, for example, may include pisci-culture systems that may harness fish manure or waste as a fertilizer for the fodder and/or veggies. Other stories, for example, may include a farmers market or produce store. In some embodiments, the multi-story food production facility may include elevators or stairs. In some embodiments, the multi-story food production facility may include a slaughterhouse, storage, creamery, slaughter house, butcher shop, cutting, and wrapping/packaging areas, and whatever else one might expect to find in an integrated facility. Extra containers, for example, can be located contiguous or adjacent to the grow facility to house elevator shafts, extra air handling/treatment systems, access, and whatever other normal building systems might be required by code for such a building.

In some embodiments, one or more shipping containers may include windows and/or greenhouse type windows. In some embodiments, one or more shipping containers may include passive or active sunlight harvesting devices.

In some embodiments, a multilevel animal or agriculture facility may include drinking water delivery systems (e.g., pipes, filters, drains, troughs, etc.) manure collection and/or transport systems, feed systems (e.g., troughs, feed distribution, conveyors, etc.), air cleaning, filtration, conditioning, heating, cooling, etc. systems. In some embodiments, the multilevel animal or agriculture facility may be a vertical farming facility and/or bio-secure food production facility. In some embodiments, animal exhaust systems in an animal facility may deliver CO₂ rich air into plant growing systems and/or plant exhaust systems in a plant facility may deliver O₂ rich air into animal facility. In some embodiments, the multilevel animal or agriculture facility may be used in urban, suburban, and rural settings FIG. 6 illustrates a shipping container according to some embodiments of the invention. The shipping container may include two top side rails 608A, 608B coupled with a top end rail 605 and a door header 606 at four corner fittings 607. The four corner fittings 607 are also coupled with four corner posts 610. Each corner post 610 is coupled with either a door sill 612 or a bottom end rail 613. Each corner post 610 is also coupled with one bottom side rail 614. A plurality of cross members 615 may extend between the bottom side rails 614. In some embodiments, one or both bottom side rails 614 may include a fork lift pocket 620 (and/or a forklift pocket strap).

The term “substantially” means within 5% or 10% of the value referred to or within manufacturing tolerances.

Various embodiments are disclosed. The various embodiments may be partially or completely combined to produce other embodiments.

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing, may readily produce alterations to, variations of, and equivalents to such embodiments. Accordingly, it should be understood that the present disclosure has been presented for-purposes of example rather than limitation, and does not preclude inclusion of such modifications, variations, and/or additions to the present subject matter as would be readily apparent to one of ordinary skill in the art.

That which is claimed:

1. A hydroponic grow facility comprising:
a first shipping container comprising a first wall and a first corner post adjacent to the first wall, wherein the first wall has at least a portion of the first wall removed;
a first fodder production apparatus disposed within the first shipping container;
a second shipping container comprising a second wall and a second corner post adjacent to the first wall, wherein the second wall has at least a portion of the second wall removed, wherein the second corner post and the first corner post are coupled together; and
a second fodder production apparatus disposed within the second shipping container.

2. The hydroponic grow facility according to claim 1, further comprising an insulator disposed on one or more surface of the first shipping container and/or the second shipping container.

3. The fodder production apparatus according to claim 1, wherein the first shipping container and the second shipping container form a single chamber or volume.

4. The hydroponic grow facility according to claim 1, further comprising a polyurethane foam covering all, most, or some of the exterior walls, ceilings, and/or flooring of the first shipping container and/or the second shipping container.

5. The hydroponic grow facility according to claim 1, further comprising:
a plurality of fasteners coupled with either or both the ceiling or wall; and
foam covering the fasteners and most of either or both the ceiling or wall.

6. The hydroponic grow facility according to claim 1, further comprising one or more beams disposed within either or both the first shipping container or the second shipping container, or above either or both the first shipping container or the second shipping container.

7. A facility comprising:
a first shipping container having four corner posts;
a second shipping container having four corner posts;
a first fodder production apparatus disposed within the first shipping container;
a second fodder production apparatus disposed within the second shipping container; and
a roof truss coupled with at least one corner post of the first shipping container and at least one corner post of the second shipping container.

8. The facility according to claim 7, wherein the truss spans the length of one or both the first shipping container and the second shipping container.

9. The facility according to claim 7, further comprising a roof structure coupled with the truss.

10. The facility according to claim 7, wherein a corner post of the first shipping container and a corner post of the second shipping container are coupled together.

11. The facility according to claim 7, wherein a corner post of the first shipping container and a corner post of the second shipping container are disposed next to one another.

12. The facility according to claim 7, wherein the truss comprises a first half truss and a second half truss that are coupled together near a central portion of either or both the first shipping container and the second shipping container.

13. A vertical farming facility comprising:
a first shipping container;
a first agricultural production facility disposed within the first shipping container;
a second shipping container disposed on top of the first shipping container; and
a second agricultural production facility disposed within the second shipping container.

14. The vertical farming facility according to claim 13, wherein the first agricultural production facility and the second agricultural production facility comprise different types of agricultural production facilities.

15. The vertical farming facility according to claim 13, wherein the first agricultural production facility and the second agricultural production facility comprise the same types of agricultural production facility.

16. The vertical farming facility according to claim 13, further comprising a third shipping container disposed on top of the second shipping container comprising a third agricultural production facility within the third shipping container.

17. The vertical farming facility according to claim 13, further comprising a plurality of shipping containers disposed one on top of the other, each of the plurality of shipping containers comprising an agricultural production facility within the respective shipping container.

18. The vertical farming facility according to claim 13, wherein the first shipping container comprises infrastructure for the second shipping container.

19. The vertical farming facility according to claim 13, wherein the first shipping container comprises manure and/or water treatment equipment.
